(19) United States
(12) Patent Application Publication
(10) Pub. No.: US 2009/0315213 A1
(43) Pub. Date: Dec. 24, 2009

(54) METHOD FOR PRODUCING TWIN TANK RAILS FOR TWO-WHEELED VEHICLE

(75) Inventor: Takahiko HASHIMOTO, Hamamatsu (JP)

Correspondence Address: BACON & THOMAS, PLLC, 625 SLATERS LANE, FOURTH FLOOR, ALEXANDRIA, VA, 22314-1176, US

(73) Assignee: KYOEI MANUFACTURING CO., LTD., Hamamatsu (JP)

(21) Appl. No.: 12/430,440

(22) Filed: Apr. 27, 2009

(30) Foreign Application Priority Data
Jun. 20, 2008 (JP) 2008-162115

(51) Int. Cl. B29C 43/00

(52) U.S. Cl. 264/295

(57) ABSTRACT

A method for producing light-weight twin tank rails of a two-wheeled vehicle including bending a rear portion of each of a pair of tubular rails downward using a roll bending machine to form a pair of primarily bent tubular rails. Each of the primarily bent tubular rails is bent using a press molding machine at its front portion to form a pair of secondarily bent tubular rails. Then, a pressurized liquid is fed into each of the second secondarily bent tubular rails while maintaining the secondarily bent tubular rail in the mold cavity of the press molding machine to plastically deform the peripheral wall thereof into conformity with the mold cavity of the corresponding press molding machine.

### CROSS-REFERENCE TO RELATED APPLICATION

This application claims, under 35 USC 119, priority of Japanese Patent Application No. 2008-162115, filed Jun. 20, 2008, disclosure of which, inclusive of the specification, claims and drawings, is hereby incorporated by reference herein.

### BACKGROUND OF THE INVENTION

### Field of the invention

The present invention relates generally to a frame of a two-wheeled vehicle such as a motorcycle and, more particularly, to a method for producing twin or paired tank rails configured to be connected to a steering head pipe in a Y-shaped configuration.

Japanese Patent Publication No. JP-A-H5-116664 discloses a related art. Disclosed is a frame of a motorcycle including right and left tank rails with a uniform rectangular cross-section along their entire length, the tank rails each having a rear portion laterally spaced apart from the rear portion of the other with its rear end joined (welded) to a corresponding one of body frames for supporting a rear arm, an engine and so on. The tank rails each have a front portion curved laterally toward the front portion of the other with its front end joined to a steering head pipe and having a stay or gusset joined to a lower portion thereof for supporting a corresponding one of down tubes.

Since the tank rails of the motorcycle frame disclosed in JP-A-H5-116664 have a uniform rectangular cross-section along their entire length, the tubular rail to form the tank rails must be selected based on the section size of the portion that is required to have the highest strength, which makes it difficult to reduce the weight and the resultant cost of the tank rails.

Japanese Patent Publication No. JP-A-H8-290790 discloses another related art. Disclosed is a frame of a motorcycle which has hollow tank rails with a rectangular cross-section each formed by bending two plate materials into a U-shape and joining them with their open sides facing each other. The tank rails can have a varying cross-sectional shape as desired, but requires many steps to produce, resulting in high production costs and low productivity.

### SUMMARY OF THE INVENTION

It is an object of the present invention to provide a method for producing a tubular curved rail in a simple manner at a low cost.

Another object of the present invention is to provide a method which can produce light-weight twin tank rails of a two-wheeled vehicle at a low cost.

According to a first aspect of the present invention, there is provided a method for producing a curved tubular rail for a twin tank rail structure of a frame of a two-wheeled vehicle, comprising the steps of:

providing a straight tubular rail having a front portion, a rear portion and a peripheral wall portion,

bending the rear portion of the straight tubular rail in a first plane to obtain a primarily bent tubular rail,

providing a pair of separable pressing molds moveable between an open position and a closed position and configured to define a curved mold cavity therebetween in the closed position,

closing the pressing molds with the primarily bent tubular rail being positioned therebetween so that the front portion of the primarily bent tubular rail is pressed within the curved mold cavity and bent in a second plane perpendicular to the first plane to obtain a secondarily bent tubular rail, and

feeding a pressurized liquid into the secondarily bent tubular rail, while maintaining the secondarily bent tubular rail in the mold cavity, to plastically deform the peripheral wall portion of the secondarily bent tubular rail into conformity with the mold cavity.

In another aspect of the present invention, there is provided a method for producing twin tank rails for a two-wheeled vehicle, characterized by comprising the steps of: bending a rear portion of each of a pair of straight tubular rails downward in a first plane by means of a roll bending machine to form a pair of primarily bent tubular rails; providing a pair of press molding machines each having a pair of pressing molds separable into right and left pressing molds and having a mold cavity contoured to correspond to an external shape of a corresponding one of right and left tank rails; pressing each of the primarily bent tubular rails from both right and left sides by means of a corresponding one of the press molding machines to form a pair of secondarily bent tubular rails each having a front portion curved in a lateral direction opposite the direction in which the front portion of the other secondarily bent tubular rail is curved; and introducing a working fluid under high pressure into each of the secondarily bent tubular rails, while maintaining the secondarily bent tubular rail in a mold cavity of the corresponding press molding machine, to plastically deform peripheral walls thereof into conformity with the mold cavity of the corresponding press molding machine.

In the above aspect of the present invention, since a rear portion of each of the tubular rails is bent downward by means of a roll bending machine, the tubular rails can be bent downward to such an extent that the size of the bracket rear arm, which is formed by a casting or press-forming process, to be joined to the rear ends of the tank rails can be reduced. Also, the lateral bending of the primarily bent tubular rails, which has been bent by means of a roll bending machine, is achieved by means of press molding machines which are also adapted for hydroforming, there is no need for a dedicated bending machine. In addition, since a working fluid is introduced into each of the secondarily bent tubular rails, which have been bent downward and laterally, in the press molding machines under high pressure to plastically deform the peripheral walls thereof into conformity with the mold cavity of the corresponding press molding machine, the portions required to have increased strength can be locally bulged out to increase the geometrical moment of inertia of the portions. Therefore, the weight of the tank rails can be reduced, and the shapes of the portions of the tank rails to which other members such as brackets, stays and gussets are to be joined can be sufficiently simple to facilitate the connection therebetween.

In a further aspect of the present invention, each of the tubular rails is generally of a rectangular cross-sectional shape having a pair of opposing parallel wide sides and a pair of opposing parallel narrow sides, and the rear portion of each of the tubular rails is first bent downward in a first plane with the wide sides extending vertically in parallel with a second plane perpendicular to the first plane by means of the roll bending machine and then the front portion of each of the tubular rails is bent laterally in the second plane by means of a corresponding one of the press molding machines.

In the above aspect of the present invention, since the bending of the tubular rails in the first plane parallel to the wide sides of the cross-section thereof, which requires a greater force, is made by means of a roll bending machine and the bending of the tubular rails in the second plane parallel to the narrow sides of the cross-section thereof is made by means of the press molding machines, the tubular rails can be smoothly bent downward in the first plane and laterally in the second plane at a low cost of equipment.

In a further aspect of the present invention, the mold cavity of each of the press molding machines of any of the foregoing aspects has one or more recesses at positions corresponding to the portion or portions of the corresponding tank rail which require increased strength or to which other members are to be joined.

In the above aspect of the present invention, since the working fluid is introduced into the secondarily bent tubular rails in the press molding machines under high pressure to cause the portion or portions of the peripheral walls of the secondarily bent tubular rails at position or positions corresponding to the one or more recesses of the press molding machines to bulge outward into the shapes of the recess or recesses, the bending rigidity of the portion or portions which require high strength can be increased and the portion or portions to which other member or members are to be joined can be formed into suitable shapes for connection therewith.

### BRIEF DESCRIPTION OF THE DRAWINGS

Other objects, features and advantages of the present invention will become apparent from the detailed description of the preferred embodiments of the invention which follows, when considered in light of the accompanying drawings in which:

FIG. 1 is a schematic side view of a motorcycle frame having a twin tank rail structure to be produced by the method of the present invention.

FIG. 2 is a schematic plan view of FIG. 1.

FIG. 3 is a partial side view of a tubular rail.

FIG. 4 is a cross-sectional view taken along the line IV-IV of FIG. 3.

FIG. 5 is a partial side view illustrating the manner in which a tubular rail is bent by means of a roll bending machine.

FIG. 6 is a planer cross-sectional view illustrating the manner in which a primarily bent tubular rail is bent by means of a press molding machine.

FIG. 7 is a side cross-sectional view illustrating the manner in which a secondarily bent tubular rail is formed by a hydroforming process.

FIG. 8 is a cross-sectional view taken along the line VIII-VIII of FIG. 7.

FIG. 9 is a cross-sectional view taken along the line IX-IX of FIG. 7.

FIG. 10 is a cross-sectional view taken along the line X-X of FIG. 7.

FIG. 11 is a cross-sectional view taken along the line XI-XI of FIG. 7.

FIG. 12 is a cross-sectional view taken along the line XII-XII of FIG. 7.

### DETAILED DESCRIPTION OF THE PREFERRED EMBODIMENT OF THE INVENTION

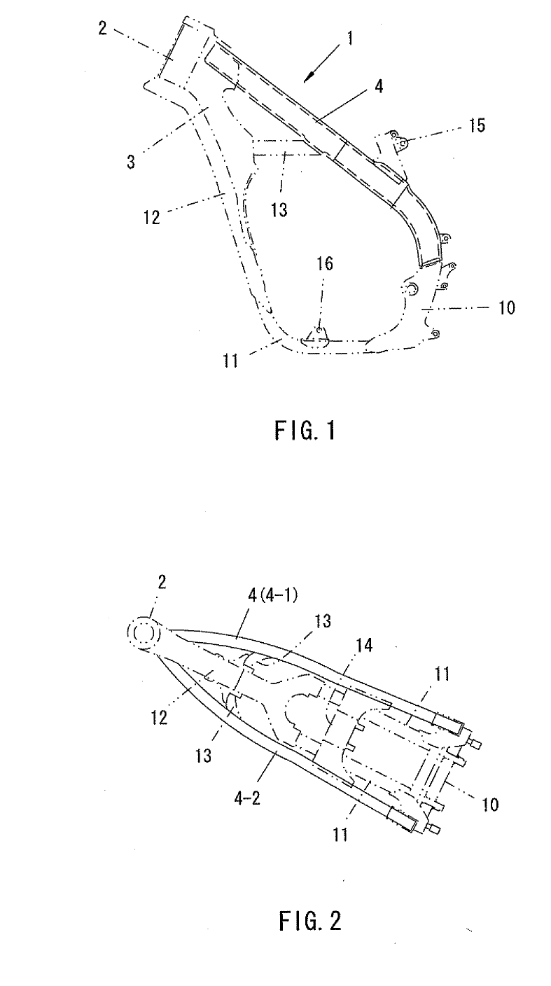

Referring to FIG. 1 and FIG. 2, designated as 1 is an aluminum alloy frame of a motorcycle having a double-cradle (loop) configuration. That is, the frame 1 has a steering head pipe 2, a pair of right and left tank rails 4 (4-1, 4-2) joined (welded) to an upper rear part of the steering head pipe 2 via a center bracket 3, and a bracket rear arm 10 having upper parts to which the rear ends of the tank rails 4 are respectively joined. As shown in FIG. 2, each to of the right and left tank rails 4 has a front portion laterally curved toward the front portion of the other with its front ends joined to the steering head pipe 2, and a rear portion spaced apart from the rear portion of the other and curved downward with its rear end joined to the bracket rear arm 10. The frame 1 also has a cylindrical under bracket 12 joined to a lower part of the steering head pipe 2, a pair of right and left down tubes 11 joined to a lower part (rear end) of the under bracket 12. The rear end of each of the down tubes 11 is joined to a lower part of the bracket rear arm 10.

The frame 1 also has reinforcing stays 13 (FIG. 1) each connecting the center bracket 3 and a longitudinal intermediate portion of a corresponding one of the tank rails 4, and a reinforcing cross pipe 14 (FIG. 2) connecting longitudinal intermediate portions of the right and left tank rails 4-1 and 4-2. Designated as 15 and 16 are coupling brackets which are secured to the tank rails 4 and the down tubes 11, respectively, and to which a rear cushion, and engine and so on are connected.

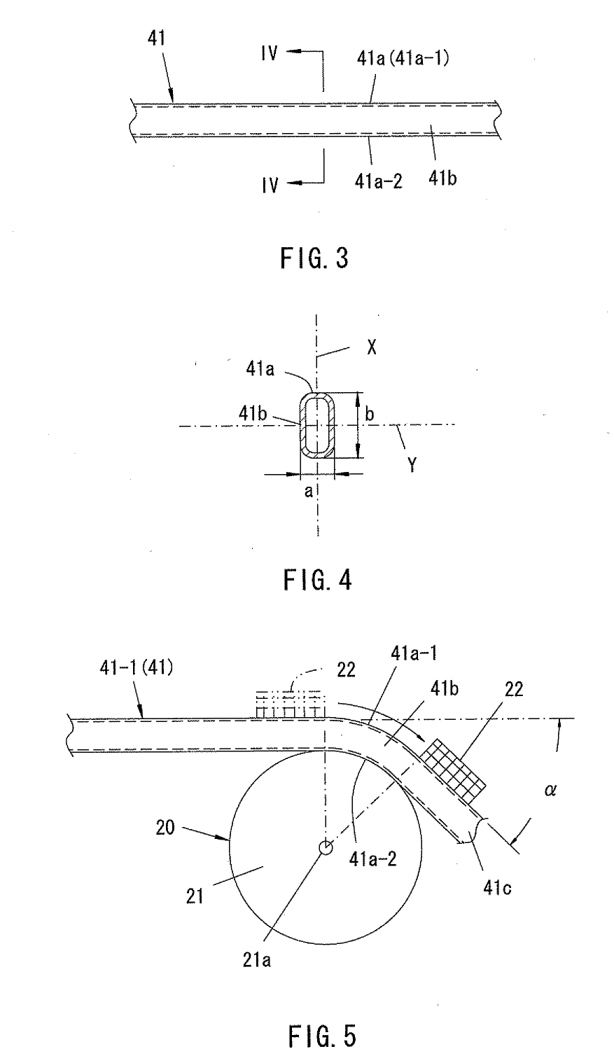

The tank rails 4 are formed as described below. First, two hollow materials (straight tubular rails) 41 with a predetermined length are obtained from a pipe material. As shown in FIG. 3 and FIG. 4, each of the straight tubular rails 41 has a generally rectangular cross-section with the width “a” of upper and lower sides (narrow sides) 41a which are smaller than the width “b” of right and left sides (wide sides) 41b. The wide sides 41b are each parallel with a first plane (vertical plane) X, while the narrow sides 41a are each parallel with a second plane (lateral plane) Y which is perpendicular to the first plane X.

Then, a rear portion 41c of each of the tubular rails 41 is bent downward by means of a roll bending machine 20 as shown in FIG. 5. That is, each of the tubular rails 41 is oriented such that the wide sides 41b are perpendicular to the center axis 21a of a bender roll 21 and placed on the bender roll 21 with its upper and lower surfaces 41a-1 and 41a-2 corresponding to the narrow sides 41a in contact with a pressing slider 22 and the outer periphery of the bender roll 21, respectively. Then, the pressing slider 22 is rotated rearward about the center axis 21a of the bender roll 21 with the tubular rail 41 held on the bender roll 21 to bend the rear portion 41c of the tubular rail 41 downward in the first plane X (FIG. 4) at a predetermined angle α, about 44° in this example. As a result, a pair of right and left primarily bent tubular rails 41-1 is obtained.

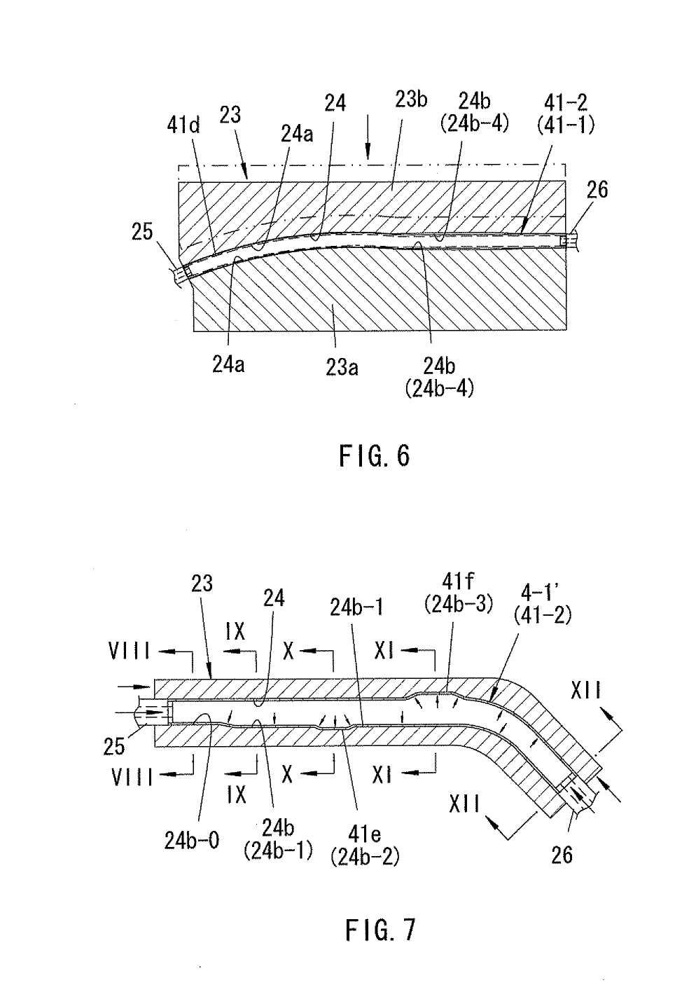

Next, the primarily bent tubular rails 41-1 are laterally bent by means of a pair of first and second press molding machines. As shown in FIG. 6, each of the press molding machines 23 has a pair of separable, right and left pressing molds 23a and 23b moveable between an open position (as shown in the two-dotted line) and a closed position (as shown in the solid line) and configured to define a curved mold cavity therebetween in the closed position. The mold cavity of the first press molding machine 23 is contoured to correspond to the external shape of the right tank rail 4-1 (FIG. 2), while the mold cavity of the second press molding machine is contoured to correspond to the external shape of the left tank rail 4-2 (FIG. 2).

FIG. 6 illustrates the first press molding machine. One of the press molds (23a) of the first press molding machine 23 is stationary and is secured to a base (not shown). The other press mold 23b is movable (up and down in this example) into contact with and away from the stationary mold 23a by a hydraulic cylinder (not shown).

The first press molding machine 23 has a mold cavity 24 having a front portion 24a curved to the left (downward in FIG. 6) as shown in FIG. 6. The mold cavity 24 is defined by upper and lower surfaces corresponding to the narrow sides 41a of the cross-section of the tubular rail 41 and right and left surfaces corresponding to the wide sides 41b of the cross-section of the tubular rail 41 as shown in FIG. 7 and FIG. 6.

The first press molding machine 23 also has a plurality of recesses 24b (four recesses 24b-1 to 24b-4 in the illustrated case) in its molding surfaces. That is, as shown in FIG. 7 and FIG. 6, the first press molding machine 23 has a first, flat recess 24b-1 formed in the lower surface along the entire length thereof except the both ends and recessed downwardly from a reference surface 24b-0, a second, trapezoidal recess 24b-2 formed in a longitudinal intermediate portion of the lower surface, a third, trapezoidal recess 24b-3 formed in a rear portion of the upper surface (as shown in FIG. 7), and fourth recesses 24b-4 formed in rear portions of the right and left surfaces as shown in FIG. 6.

In operation, one of the primarily bent tubular rails 41-1 as described before is fitted in the stationary mold 23a, and the movable mold 23b is moved into mating contact with the stationary mold 23a (from the open position shown by the two-dotted line to the closed position shown in the solid line in FIG. 6) to bend a front portion 41d of the primarily bent tubular rail 41-1 to the left (downward in FIG. 6) in the second plane Y (FIG. 4) which is parallel with the narrow sides 41a of the primarily bent tubular rail 41-1, thereby obtaining a secondarily bent tubular rail 41-2.

Next, while maintaining the secondarily bent tubular rails 41-2 in the mold cavity 24 of the first press molding machine 23, a pressurized liquid (working fluid such as water or oil) is fed into the secondarily bent tubular rail to plastically deform the peripheral wall portion of the secondarily bent tubular rail 41-2 into conformity with the mold cavity 24.

To this end, liquid inlets 25 and 26 are attached to the front and rear ends of the secondarily bent tubular rail 41-2 as shown in FIGS. 6 and 7. The secondarily bent tubular rail 41-2 is axially pressed from both sides via the liquid inlets 25 and 26 as the working fluid is introduced under high pressure into the secondarily bent tubular rail 41-2 through the liquid inlets 25 and 26. As a result, the peripheral walls of the secondarily bent tubular rail 41-2 can be plastically deformed into conformity with the mold cavity 24 of the first press molding machine 23 as shown in FIG. 7.

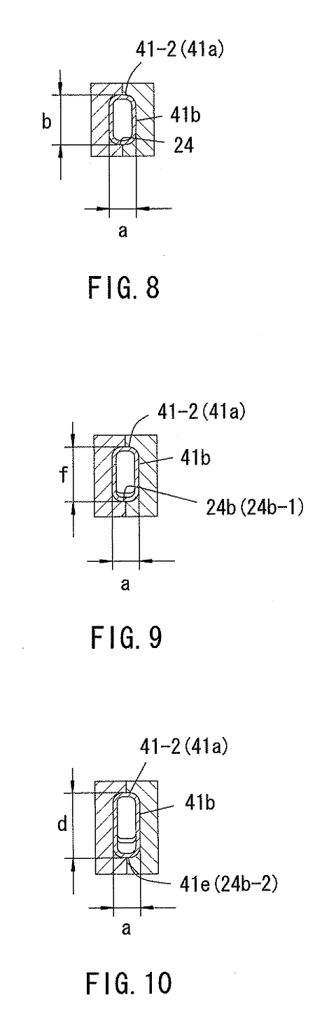

Thus, the cross-sectional shape of the secondarily bent tubular rail 41-2 taken along the lines VIII-VIII (at the front end) and along the line XII-XII (at the rear end) in FIG. 7 remains the same as that of the tubular rail 41 as shown in FIG. 8 and FIG. 12, whereas the portion of the peripheral wall of the secondarily bent tubular rail 41-2 at a position corresponding to the first recess 24b-1 is bulged out such that the cross-section taken along the line IX-IX of FIG. 7 has an increased wide side length of “f” and an increased circumference which is about 1.1 times greater than that of the tubular rail 41 as shown in FIG. 9.

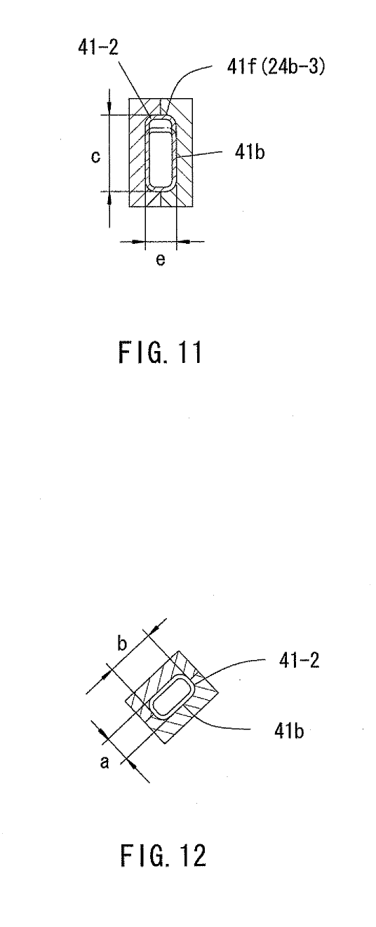

Also, the portion of the peripheral wall of the secondarily bent tubular rail 41-2 at a position corresponding to the second recess 24b-2 is bulged out into a trapezoidal shape such that the cross-section taken along the line X-X of FIG. 7 has an increased wide side length of “d” and an increased circumference which is about 1.2 times greater than that of the tubular rail 41 as shown in FIG. 10. Further, the portion of the peripheral wall of the secondarily bent tubular rail 41-2 at a position corresponding to the third recess 24b-3 is bulged out into a trapezoidal shape and, additionally, the portions of the peripheral walls of the secondarily bent tubular rail 41-2 at positions corresponding to the fourth recesses 24b-4 are bulged out. As a consequence, as shown in FIG. 11, the cross-sectional shape taken along the line XI-XI of FIG. 7 has an increased wide side length of “c” an increased narrow side length of “e” and an increased circumference which is about 1.3 times greater than that of the tubular rail 41. As a result of the foregoing steps, a molded product 4-1′ for the right tank rail 4-1 (FIG. 2) is obtained.

A molded product for the left tank rail 4-2 (FIG. 2) is formed in the same manner as described above by means of the second press molding machine. Then, the molded products (4-1′ and 4-2′) formed by means of the press molding machines (first and second press molding machines) 23 are finish-machined at their front and rear ends and are joined to the steering head pipe 2 and the bracket rear arm 10. Also, the reinforcing stays 13, the cross pipe 14, the coupling brackets 15 and so on shown in FIG. 1 and FIG. 2 are joined to trapezoidal bulged portions 41e and 41f formed in conformity with the second and third recesses 24b-2 and 24b-3 shown in FIG. 7.

According to the above embodiment, since the tank rails with complicated shapes, each of which has a rear portion curved downward, a front portion curved laterally, and bulged portions at their longitudinal intermediate portions, can be formed from a simple linear tubular rail, the material cost can be reduced. In addition, the geometrical moment of inertia of the portions which require high strength can be increased. Also, the portions to which other members are to be joined can be formed into suitable shapes for connection therewith by locally bulging the peripheral walls of the tubular rails outward. Thus, the weight of the tank rails can be reduced and the connection between the tank rails and other members can be facilitated. Especially, since the primarily bent tubular rails bent by means of a roll bending machine are bent laterally by means of press molding machines adapted for forming bulged portions by hydroforming, there is no need for a dedicated bending machine for bending the primarily bent tubular rails laterally and the number of processing steps and the cost of equipment can be reduced.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

What is claimed is:

1. A method for producing a curved tubular rail for a twin tank rail structure of a frame of a two-wheeled vehicle, comprising the steps of:
providing a straight tubular rail having a front portion, a rear portion and a peripheral wall portion,
bending the rear portion of the straight tubular rail in a first plane to obtain a primarily bent tubular rail,
providing a pair of separable pressing molds moveable between an open position and a closed position and configured to define a curved mold cavity therebetween in the closed position,
closing the pressing molds with the primarily bent tubular rail being positioned therebetween so that the front portion of the primarily bent tubular rail is pressed within the curved mold cavity and bent in a second plane perpendicular to the first plane to obtain a secondarily bent tubular rail, and
feeding a pressurized liquid into the secondarily bent tubular rail, while maintaining the secondarily bent tubular rail in the mold cavity, to plastically deform the peripheral wall portion of the secondarily bent tubular rail into conformity with the mold cavity.

2. The method as recited in claim 1, wherein the straight tubular rail has generally a rectangular cross-sectional shape and has opposing parallel wide sides and opposing parallel narrow sides normal to the wide sides, and wherein the rear portion is first bent by means of a roll bending machine with the wide sides being maintained in parallel with the first plane and then the front portion is bent by means of the pressing molds with the narrow sides being maintained in parallel with the second plane.

3. The method as recited in claim 1, wherein the mold cavity has one or more recesses so that one or more bulged portions are correspondingly formed in the peripheral wall portion of the secondarily bent tubular rail as a result of the plastic deformation.

4. A method for producing twin tank rails of a frame of a two-wheeled vehicle, comprising the steps of:
providing a pair of straight tubular rails each having a front portion, a rear portion and a peripheral wall portion,
bending the rear portion of each of the pair of straight tubular rails in a first plane by means of a roll bending machine to form a pair of first and second primarily bent tubular rails;
providing a pair of first and second molding machines each having a pair of separable pressing molds relatively moveable between an open position and a closed position and configured to define a curved mold cavity therebetween in the closed position;
closing the pressing molds of the first molding machine with the first primarily bent tubular rail being positioned therebetween so that the front portion of the first primarily bent tubular rail is pressed within the curved mold cavity and bent in a first direction lying in a second plane perpendicular to the first plane to obtain a first secondarily bent tubular rail,
feeding a pressurized liquid into the first secondarily bent tubular rail, while maintaining the first secondarily bent tubular rail in the mold cavity of the first molding machine, to plastically deform the peripheral wall portion of the first secondarily bent tubular rail into conformity with the mold cavity thereof,
closing the pressing molds of the second molding machine with the second primarily bent tubular rail being positioned therebetween so that the front portion of the second primarily bent tubular rail is pressed within the curved mold cavity and bent in a second direction lying in a second plane perpendicular to the first plane to obtain a second secondarily bent tubular rail, and
feeding a pressurized liquid into the second secondarily bent tubular rail, while maintaining the second secondarily bent tubular rail in the mold cavity of the second molding machine, to plastically deform the peripheral wall portion of the second secondarily bent tubular rail into conformity with the mold cavity thereof, said first and second directions, in which the front portions of the first and second secondarily bent tubular rails are bent, being generally symmetric with each other with respect to the first plane in which the rear portion of each of the first and second secondarily bent tubular rails lies.

5. The method as recited in claim 4, wherein each of the pair of straight tubular rails has generally a rectangular cross-sectional shape and has opposing parallel wide sides and opposing parallel narrow sides normal to the wide sides, and wherein the rear portion of each of the pair of straight tubular rails is first bent by means of a roll bending machine with the wide sides thereof being maintained in parallel with the first plane and then the front portion of each of the pair of straight tubular rails is bent by means of the corresponding molding machine with the narrow sides thereof being maintained in parallel with the second plane.

6. The method as recited in claim 4, wherein the mold cavity of each of the first and second molding machines has one or more recesses so that one or more bulged portions are correspondingly formed in the peripheral wall portion of each of the first and second secondarily bent tubular rails as a result of the plastic deformation.
